(19) United States
(12) Patent Application Publication
(10) Pub. No.: US 2024/0257273 A1
(43) Pub. Date: Aug. 1, 2024

(54) LIKELIHOOD OF FLAME WAR DETERMINATION APPARATUS, LIKELIHOOD OF FLAME WAR DETERMINATION METHOD AND PROGRAM

(71) Applicant: NIPPON TELEGRAPH AND TELEPHONE CORPORATION, Tokyo (JP)

(72) Inventors: Keita SUZUKI, Tokyo (JP); Atsushi NAKADAIRA, Tokyo (JP); Shigenori OHASHI, Tokyo (JP); Shigeru FUJIMURA, Tokyo (JP); Honoka TODA, Tokyo (JP)

(21) Appl. No.: 18/563,994

(22) PCT Filed: May 31, 2021
(86) PCT No.: PCT/JP2021/020664

§ 371 Date: Nov. 24, 2023

(51) Int. Cl. G06Q 50/00

(52) U.S. Cl. CPC G06Q 50/01

(57) ABSTRACT

A flammability determination device including a first determination unit that determines whether a posting frequency of a first user who has posted a certain posting to a first SNS to the first SNS has a predetermined deviation from an average of posting frequencies of all users who use the first SNS, an estimation unit that estimates an experience value indicating a level of experience related to use of the Internet based on a possibility of use of a second SNS different from the first SNS for the first user when the predetermined deviation exists, and a second determination unit that determines whether a negative expression is included in content of the certain posting in a case where the experience value is less than a first threshold value, and if the negative expression is included, adds content of the certain posting to a collection of posting contents having a possibility of flaming, thereby collecting posted content that has a high possibility of flaming due to carelessness.

### TECHNICAL FIELD

The present invention relates to a flammability determination device, a flammability determination method, and a program.

### BACKGROUND ART

In the past, a prediction of the flaming in the social networking service (SNS), bulletin boards, or the like has been performed. Conventionally, systems for preventing the occurrence of the flaming has been constructed by collecting frequently appearing words and swearing expressions in the flaming in advance and learning the frequently appearing words and swearing expressions in the flaming using machine learning.

From the viewpoint of constructing a prediction model of the flaming tweets, a study is made to extract a topic of utterance, and examine how the public reviews of the topic change, and predict the flaming.

### CITATION LIST

### Non Patent Literature

NPL 1: Flame prediction based on harmful expression using distributed representation, Interactive Information Access and Visual Mining Workshop-SIG-AM (2017)
NPL 2: Analysis of Flaming and its Application in CGM, Transactions of the Japanese Society for Artificial Intelligence, vol. 30, No. 1
NPL 3: The proposal of the list combination system in prevention and suppression of pseudo crime expression to Twitter, Information Processing Society of Japan, Research Report Groupware and Network Services (GN) 2012

### SUMMARY OF INVENTION

### Technical Problem

In the past, the past flaming tweets are collected from the whole Twitter (registered trademark), and simple feature quantities such as surface layer information of words and co-occurrence relation of adjacent words are learned to perform flaming prediction, but it is difficult to say that accuracy is high. Twitter (registered trademark) has a result of verification that various expressions such as monology or a posting to a friend are mixed and only about 70% can be detected.

Various types of the flaming are generated by carelessness of the poster himself or herself, intentionally generated by self-action or the like, stealth marketing or the like. If the prediction of the flaming is intended to be performed by covering all of these, it is difficult to improve the accuracy of the prediction of the flaming. Among these, in the case of flaming caused by carelessness of the poster himself or herself, there is a case where a serious damage with a large mental burden which is not assumed by the person himself or herself is caused, such as harassment from the net user and information on the poster are spread on the net, and personal information of the poster is specified. In order to prevent such damage from being enlarged, it is necessary to suppress the occurrence of the flaming. For this purpose, it is necessary to collect posting contents which are the highly flaming possibility due to carelessness.

The present invention has been made in view of the above points, and an object of the present invention is to make it possible to collect posting content with a high possibility of the flaming due to carelessness.

### Solution to Problem

In order to solve the above problem, a flammability determination device including a first determination unit that determines whether a posting frequency of a first user who has posted a certain posting to a first SNS to the first SNS has a predetermined deviation from an average of posting frequencies of all users who use the first SNS, an estimation unit that estimates an experience value indicating a level of experience related to use of the Internet based on a possibility of use of a second SNS different from the first SNS for the first user when the predetermined deviation exists, and a second determination unit that determines whether a negative expression is included in content of the certain posting in a case where the experience value is less than a first threshold value, and if the negative expression is included, adds content of the certain posting to a collection of posting contents having a possibility of flaming.

### Advantageous Effects of Invention

The posting content with the high possibility of the flaming due to carelessness can be collected.

### BRIEF DESCRIPTION OF DRAWINGS

FIG. 1 is a diagram illustrating a system configuration example in an embodiment of the present invention.

FIG. 2 is a diagram illustrating a hardware configuration example of a flammability determination device 10 in the embodiment of the present invention.

FIG. 3 is a diagram illustrating a functional configuration example of the flammability determination device 10 in the embodiment of the present invention.

FIG. 4 is a diagram illustrating a configuration example of a post-related information storage unit 16.

FIG. 5 is a flowchart illustrating an example of processing procedures executed by a flaming candidate determination unit 12.

FIG. 6 is a diagram illustrating a configuration example of a flaming candidate storage unit 17.

FIG. 7 is a diagram illustrating a configuration example of an other SNS information storage unit 18.

FIG. 8 is a flowchart for illustrating an example of processing procedures executed by an experience value estimation unit 14.

FIG. 9 is a diagram illustrating a configuration example of a corpus storage unit 19.

### DESCRIPTION OF EMBODIMENTS

It is considered that a person is made uncomfortable by careless posting (such as tweets) to social networking service (SNS), and that the person is considered as a factor causing the occurrence of the flaming, because of lack of attention and lack of experience. In the present embodiment, a user (poster) considered to be insufficient in experience and attention is also insufficient is specified, and posting contents such as the tweets with a high possibility of flaming due to carelessness of the user himself or herself (hereinafter, referred to as “flaming posting content”) is stored in a corpus. The determination of the flammability is made from the contents of the posting and the language expression of the reply. The flaming is, for example, a large number of criticisms that are gathered with respect to the transmitted information.

In the present embodiment, a user having a relatively low posting frequency is specified as a user having insufficient experience, and a user having a relatively high posting frequency is specified as a user having insufficient attention. When carefully posting, the contents are well examined and posted with time, but when attention is low, there is a tendency to post continuously without scrutinizing the contents, so that the attention is paid to the number of posting frequencies for the lack of attention.

In the present embodiment, for a user specified as having insufficient experience or insufficient attention, an experience value related to the use of the Internet is calculated based on the elapsed time from the creation of an account related to posting, the possibility of using another SNS, and the like.

In the present embodiment, further, the possibility of the flaming of the posting contents by the user is determined based on the experience value of the user specified as having the lack of experience or the lack of attention.

Note that the posting content refers to some expression using a natural language, a symbol or the like. However, an image, a voice, or the like may be included in the posting content.

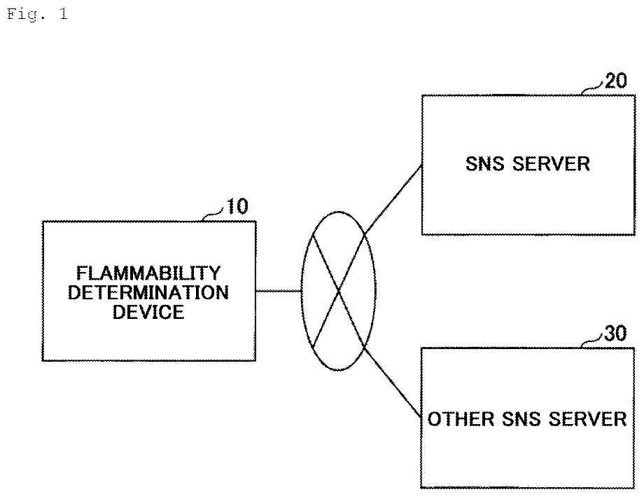

Embodiments of the present invention will be described below with reference to the drawings. FIG. 1 is a diagram illustrating a system configuration example according to an embodiment of the present invention. In FIG. 1, a flammability determination device 10 is connected to an SNS server 20, another SNS server 30, or the like via a network such as the Internet.

The flammability determination device 10 is one or more computers for extracting (specifying) the flaming posting content from the content of the posting posted to the SNS server 20, and generating a corpus as a collection of the extracted (specified) flaming posting content.

The SNS server 20 is one or more computers that provide an SNS (hereinafter, referred to as “target SNS”) from which the flaming posting content is extracted by the flammability determination device 10.

The other SNS server 30 is one or more computers that provide an SNS other than the target SNS (hereinafter, referred to as “other SNS”). The other SNS may not be a specific one SNS, and may be a set of a plurality of SNSs.

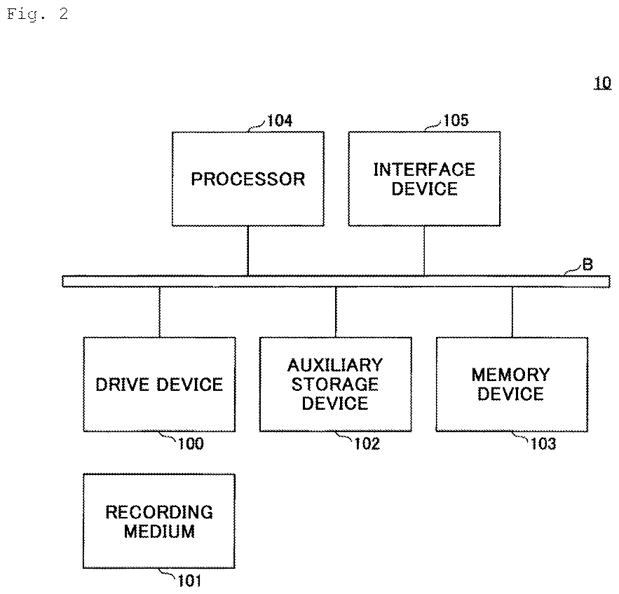

FIG. 2 is a diagram illustrating a hardware configuration example of the flammability determination device 10 according to the embodiment of the present invention. The flammability determination device 10 illustrated in FIG. 2 includes a drive device 100, an auxiliary storage device 102, a memory device 103, a processor 104, an interface device 105, and the like which are connected to each other by a bus B.

A program that realizes processing in the flammability determination device 10 is provided by a recording medium 101 such as a CD-ROM. When the recording medium 101 storing the program is set in the drive device 100, the program is installed from the recording medium 101 to the auxiliary storage device 102 via the drive device 100. However, the program does not necessarily have to be installed from the recording medium 101 and may be downloaded from another computer via a network. The auxiliary storage device 102 stores the installed program as well as necessary files, data, and the like.

The memory device 103 reads out and stores the program from the auxiliary storage device 102 in a case where an instruction to activate the program is issued. The processor 104 is a CPU or a graphics processing unit (GPU), or a CPU and a GPU, and executes functions related to the flammability determination device 10 in accordance with the program stored in the memory device 103. The interface device 105 is used as an interface to connect to a network.

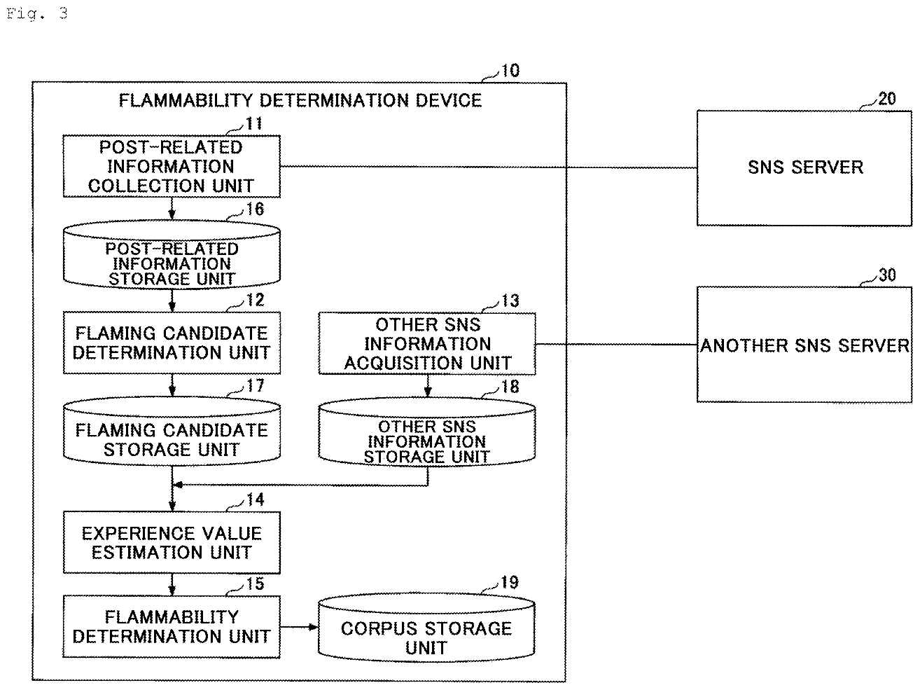

FIG. 3 is a diagram illustrating a functional configuration example of the flammability determination device 10 in the embodiment of the present invention. As illustrated in FIG. 3, the flammability determination device 10 includes a post-related information collection unit 11, a flaming candidate determination unit 12, an other SNS information acquisition unit 13, an experience value estimation unit 14, and a flammability determination unit 15. Each of these units is realized by one or more programs installed in the flammability determination device 10 causing the processor 104 to execute processing. The flammability determination device 10 also uses a post-related information storage unit 16, a flaming candidate storage unit 17, an other SNS information storage unit 18, and a corpus storage unit 19. These storage units can be achieved using, for example, the auxiliary storage device 102, a storage device that can be connected to the flammability determination device 10 via a network, or the like.

The processing contents executed by each unit will be described below.

### [Post-Related Information Collection Unit 12]

The post-related information collection unit 11 inputs information (hereinafter, referred to as “post-related information”) related to the post (for example, referred to as target posting) every time a post content (hereinafter, referred to as “target posting content”) occurs after a predetermined time (for example, 12 hours) has passed since it was posted on the target SNS and outputs (stores) the input post-related information to the post-related information storage unit 16.

The post-related information is information including values of items such as a “posting content,” a “user name,” a “profile sentence,” a “posting date,” a “reply,” a “number of replies,” a “number of likes,” a “number of re-postings,” a “number of blocks,” “account creation date and time,” the “number of “likes” given by the posting user,” the “number of cumulative postings,” the “average number of posting user's postings per day,” and the “average number of all users' postings per day.”

The “posting content” about the target posting is the target posting content. The “user name” about the target posting is a name of a user who has posted the target posting content (hereinafter, referred to as “target user”). The “profile sentence” about the target posting is a sentence (character string) indicating the profile of the target user. The “posting date and time” about the target posting is a date and time when the target posting content is posted to the target SNS. The “reply” about the target posting is one or more postings as a response to the target posting content. The “number of replies” for the target posting is the number of postings included in the “reply” for the target posting. The “number of likes” about the target posting is the number (number of positive reactions) in which information of “likes” is given to the target posting content by a user other than the target user who has read the target posting. The “number of re-postings” about the target posting is the number of times of posting (for example, retweet) by the target user about the same content as the target posting content. The “number of blocks” for the target posting is the number of accounts of other users who are blocked in the target SNS by the target user at the time of the target posting. The “account creation date and time” about the target posting is a date and time when the target user has created an account for the target SNS. The “number of “likes” given by the posting user” about the target posting is the number of “likes” given to the posting of another user by the target user in a period from the account creation date to the target posting time point (that is, a use period of the target SNS by the target user). The “number of cumulative postings” about the target posting is the number of cumulative postings to the target SNS by the target user until the target posting time. The “average number of posting user's postings per day” for the target posting is a value indicating the posting frequency of the target user, and is the average number of target user's postings per day until the target posting time (or until the previous day of the posting). The “average posting number of all users' postings per day” for the target posting is a value indicating an average of posting frequencies of all users of the target SNS, and the average number of all users' postings per day until the target posting time point (or until the previous day of the posting).

When it is difficult to directly input statistical information such as the “number of cumulative postings,” the “average number of posting user's postings per day,” and the “average number of all users' postings per day” from the SNS server 20, these values may be acquired by performing retrieval to the SNS server 20 by the post-related information collection unit 11. Specifically, the “number of cumulative postings” can be obtained by retrieving for all the past postings of the target user (until the target posting time point or until the previous day of the target posting) and counting the number of the retrieved postings. The “average number of the posting user's postings per day” can be obtained by dividing the number of cumulative postings of the target user by an elapsed date from the account creation date and time of the target user to the target posting time point or the previous date of the target posting. The “average number of all users' postings per day” can be obtained by counting the number of all postings registered in the SNS server 20 and dividing the number of postings by the number of days elapsed from the start of posting to the SNS server 20 to the target posting time point or the previous day of the target posting. However, the “average number of all users' postings per day” may be calculated for a predetermined period such as one year in the past.

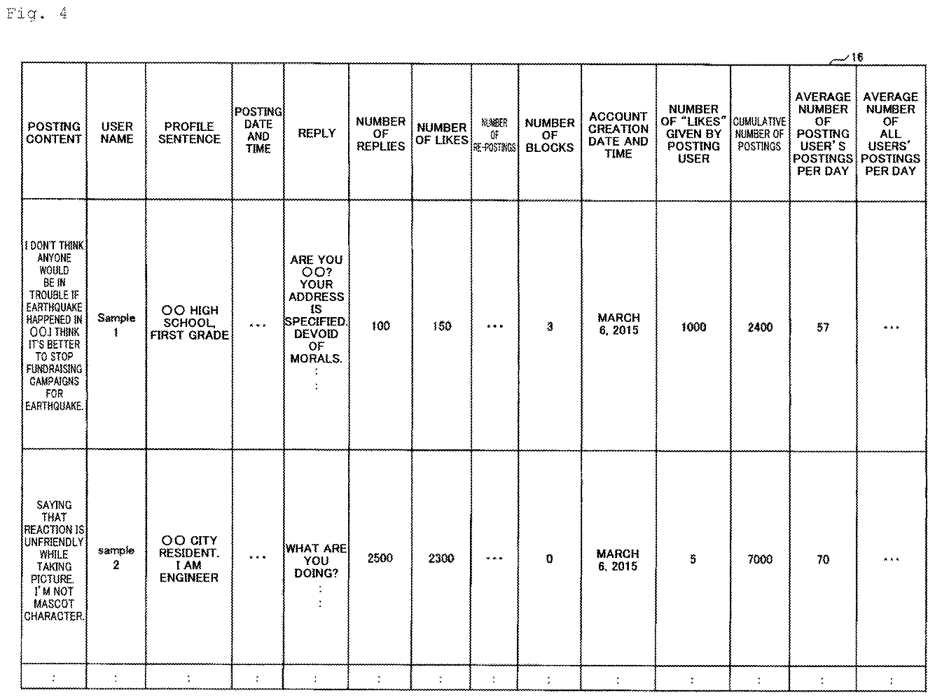

FIG. 4 is a diagram illustrating a configuration example of the post-related information storage unit 16. As illustrated in FIG. 4, the post-related information storage unit 16 stores values of respective items constituting the post-related information for each piece of the post-related information output by the post-related information collection unit 11.

### [Flaming Candidate Determination Unit 12]

The flaming candidate determination unit 12 inputs the post-related information stored in the post-related information storage unit 16, and determines the possibility of insufficient experience or insufficient attention related to the target SNS about the user who has posted the post-related information. This is because the posting by the user who may have insufficient experience or insufficient attention has the relatively high possibility of the flaming. When it is determined that the user has insufficient experience or insufficient attention, the flaming candidate determination unit 12 outputs (stores) the post-related information (or the information of a part of the post-related information) to the flaming candidate storage unit 17, and otherwise, does not output (store) the post-related information to the flaming candidate storage unit 17.

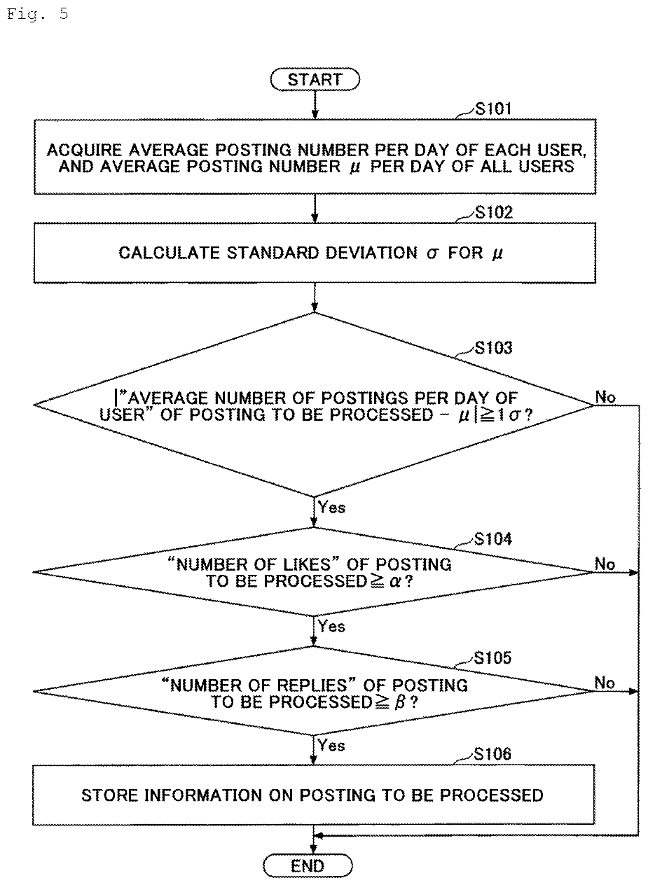

FIG. 5 is a flow chart for illustrating an example of the processing procedure executed by the flaming candidate determination unit 12. The processing procedure illustrated in FIG. 5 may be executed following the processing by the post-related information collection unit 11 or may be executed every predetermined time (for example, every 12 hours). In the former case, the post-related information to be processed in FIG. 5 is the post-related information finally output to the post-related information storage unit 16 by the post-related information collection unit 11. In the latter case, the post-related information to be processed in FIG. 5 is the post-related information stored in the post-related information storage unit 16 at the latest fixed time. In a case where there are a plurality of pieces of corresponding post-related information, the processing illustrated in FIG. 5 may be executed for each of the plurality of pieces of post-related information. Hereinafter, one piece of “post-related information” to be processed is referred to as “target post-related information”.

In step S101, the flaming candidate determination unit 12 acquires the latest “average number of the posting user's postings per day” of each user and the latest “average number of all users' postings per day” from the post-related information storage unit 16 (FIG. 4). Here, the latest “average number of posting user's postings per day” of a certain user refers to “average number of posting user's postings per day” included in latest post-related information including a user name of the user. It (the “average number of the posting user's postings per day”) is acquired for each user. The latest “average number of all users' postings per day” means “average number of all users' postings per day” included in one piece of post-related information finally stored in the post-related information storage unit 16, and the value is one. Hereinafter, the latest “average number of all users' postings per day” is referred to as “u”. Here, u corresponds to the average of the latest “average number of the posting user's postings per day” of each user.

Then, the flaming candidate determination unit 12 calculates a standard deviation σ related to μ for the latest “average number of the posting user's postings per day” of each user (S102).

Then, the flaming candidate determination unit 12 determines whether an absolute value of a difference between the “average number of the posting user's postings per day” and u of the target post-related information is 10 or more (S103). That is, it is determined whether the “average number of the posting user's postings per day” is smaller by 10 or less or greater by 10 or more than u. Such a determination corresponds to a determination of whether or not the “average number of the posting user's postings per day” of the target post-related information has a predetermined deviation with respect to the “average number of all users' postings per day”. Also a determination means a determination as to whether the user related to the target posted related information (hereinafter, referred to as “target user”) is inexperienced or has insufficient attention. That is, in the present embodiment, in a case where the “average number of the posting user's postings per day” is smaller than u by 10 or less, it is determined that the target user is insufficient in experience with respect to the target SNS. On the other hand, when the “average number of the posting user's postings per day” is greater than μ by 1 σ or more, it is determined that the target user is insufficient in attention with respect to the target SNS. Although an example in which the threshold value for the difference is 1 σ has been described, values other than 1 σ may be used as the threshold value.

In a case where the absolute value of a difference between the “average number of the posting user's postings per day” of the target post-related information and μ is less than 1 σ (No in S103), processing after the step S104 is not executed for the target post-related information.

In a case where the absolute value of a difference between the “average number of the posting user's postings per day” of the target post-related information and μ is 1 σ or more (Yes in S103), the flaming candidate determination unit 12 determines whether the “number of likes” of the target post-related information is equal to or more than a threshold α (S104). The threshold α is a value preset as a value representing a reaction to the flaming post, for example, 100. In a case where the “number of likes” is less than a threshold α (No in S104), processing after the step S105 is not executed for the target post-related information.

In a case where the “number of likes” is equal to or more than 100 (Yes in S104), the flaming candidate determination unit 12 determines whether the “number of replies” of the target post-related information is equal to or more than a threshold β (S105). The threshold β is a value preset as a value representing a reaction to the flaming post, for example, 100. In a case where the “number of replies” is less than the threshold β (No in S105), the step S106 is not executed for the target post-related information. In a case where the “number of replies” is equal to or more than the threshold β (Yes in S105), the flaming candidate determination unit 12 stores information necessary for determining the possibility of flaming in the flaming candidate storage unit 17 among pieces of information constituting the target post-related information (S106).

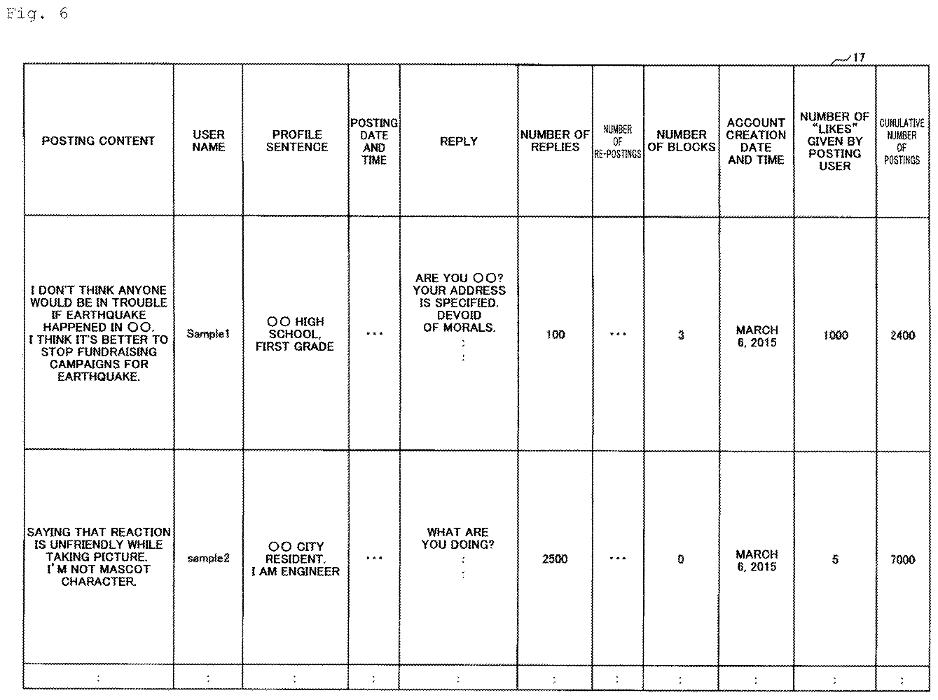

FIG. 6 is a diagram illustrating a configuration example of the flaming candidate storage unit 17. As illustrated in FIG. 6, among the post-related information items stored in the post-related information storage unit 16, information including the “posting content,” a “user name,” a “posting content,” a “profile sentence,” “posting date and time,” a “reply,” the “number of replies,” the “number of re-postings,” the “number of blocks,” “account creation date and time,” the “number of “likes” given by the posting user,” and the “number of cumulative postings” (hereinafter, referred to as “candidate posting information”) of the post-related information that meets the conditions of steps S103 to S105 of FIG. 5 are stored in the post-related information storage unit 16.

### [Other SNS Information Acquisition Unit 13]

The other SNS information acquisition unit 13 acquires, for example, a user name of each account registered in the other SNS from the other SNS server 30 at every fixed time (every 12 hours), and stores the acquired user name in the other SNS information storage unit 18. In a case where the acquired user name is already stored in the other SNS information storage unit 18, the other SNS information acquisition unit 13 does not need to store the user name in the other SNS information storage unit 18.

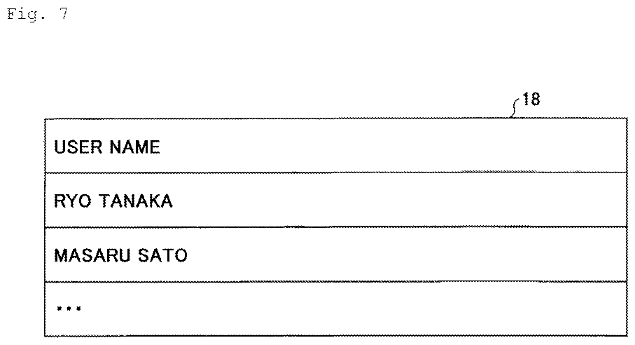

FIG. 7 is a diagram illustrating a configuration example of the other SNS information storage unit 18. As illustrated in FIG. 7, the other SNS information storage unit 18 stores information including “user name” of each account registered in the SNS server 30 (hereinafter, referred to as “other SNS information”).

### [Experience Value Estimation Unit 14]

The experience value estimation unit 14 inputs the candidate posting information stored in the flaming candidate storage unit 17 and the other SNS information stored in the other SNS information storage unit 18, and calculates an experience value of a user related to the candidate posting information. When the experience value is equal to or less than a threshold γ (that is, when the possibility that the user is insufficient in experience is high), the experience value estimation unit 14 outputs a posting content and a reply of the candidate posting information. The experience value calculated by the experience value estimation unit 14 is an index indicating the level of experience related to the use of the Internet including not only the target SNS but also the other SNS. The threshold γ is a value set in advance based on the experience value calculated by the experience value estimation unit 14. As an example, an average is calculated from a value (d) of each experience value of an experience value estimation unit 14, and the average is used as a threshold.

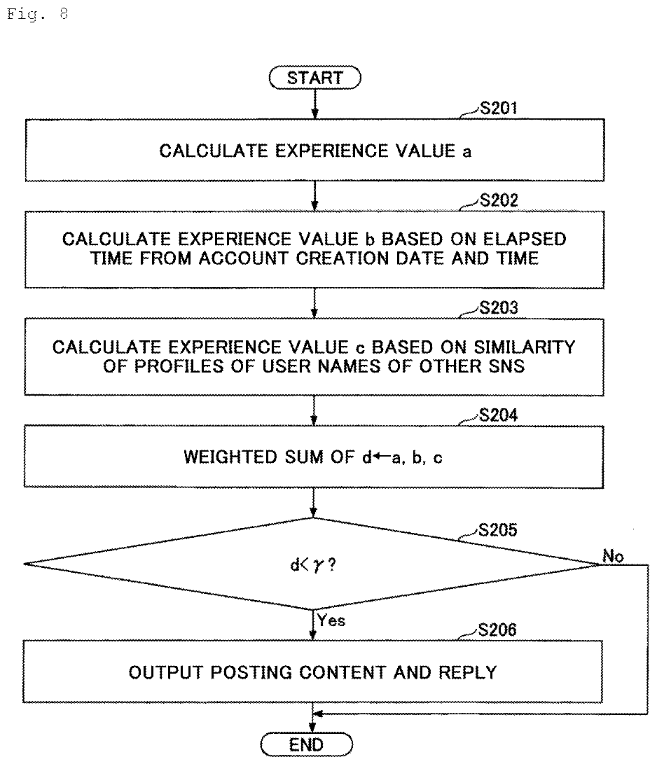

FIG. 8 is a flow chart for illustrating an example of the processing procedure executed by the experience value estimation unit 14. The processing procedure illustrated in FIG. 8 may be executed following the processing by the flaming candidate determination unit 12, or may be executed every predetermined time (for example, every 12 hours). In the former case, the candidate posting information to be processed in FIG. 8 is the candidate posting information finally outputted to the flaming candidate storage unit 17 by the flaming candidate determination unit 12. In the latter case, the candidate posting information to be processed in FIG. 8 is the candidate posting information stored in the flaming candidate storage unit 17 at the latest fixed time. If there are a plurality of corresponding candidate posting information items, the processing illustrated in FIG. 8 may be executed for each of the plurality of candidate posting information items. Hereinafter, one “candidate posting information” item to be processed is referred to as “target candidate posting information”.

In step S201, the experience value estimation unit 14 calculates an experience value a related to the user (hereinafter, referred to as “target user”) related to the target candidate posting information based on the “posting content,” the “number of cumulative postings,” the “number of re-postings,” the “number of “likes” given by the posting user,” and the “number of blocks” of the target candidate posting information.

The experience value a is calculated using Equation (1) below in a case where the “posting content” of the target candidate posting information does not include a hashtag, and is calculated using Equation (2) below in a case where the “posting content” of the target candidate posting information includes the hashtag.

Experience value a=(T+I+RT+10B)/Average number of cumulative postings (1)

Experience value a=(2T+I+RT+10B)/Average number of cumulative postings (2)

Here, the meaning of each variable is as follows.
T: “Number of cumulative postings”
RT: “Number of re-postings”
I: “Number of “likes” given by posting user”
B: “Number of blocks”

That is, in a case where the “posting content” includes a hashtag, the weight (contribution) of the “number of cumulative postings” to the experience value a is doubled. The average number of cumulative postings is an average value of the cumulative posting number of each user. The experience value a is normalized by dividing by the average number of cumulative postings.

Subsequently, the experience value estimation unit 14 calculates an experience value b based on the number of elapsed days from the “account creation date and time” of the target candidate posting information to the “posting date and time” of the target candidate posting information (S202). The experience value b is calculated, for example, based on Equation (3).

B=P/365

Here, P is the number of days elapsed from the “account creation date and time” to the “posting date and time”. The denominator 365 is the number of days per year. The experience value b is normalized by dividing the number of days elapsed by 365.

Subsequently, the experience value estimation unit 14 calculates an experience value c based on the similarity between the “user name” of the target candidate posting information (hereinafter, referred to as “target user name”) and each “user name” (hereinafter, referred to as the “other user name”) of other SNS information stored in the other SNS information storage unit 18 (FIG. 7) (S203).

That is, even in a case where it is determined that the experience of the target SNS is low for the target user, in a case where the target user uses another SNS, it is considered that the experience value of the Internet of the target user is high. Therefore, in step S203, the accuracy of the experience value is improved by confirming whether the target user uses another SNS. In the present embodiment, if an account having another user name similar to the target user name is present in the other SNS in order to confirm whether the target user is using the other SNS, the account is determined to be the account of the target user. That is, in this case, it is determined that the target user is using another SNS.

Specifically, the experience value estimation unit 14 calculates, for each of the other user names, similarity with the target user name about the other user name. As the similarity, for example, a Levenshtein distance may be used. A Levenshtein distance D (C1, C2) between a character string C1 and a character string C2 is evaluated by the minimum number of procedures required for deforming the character string C1 into the character string C1 by insertion, deletion, substitution, or the like of characters. The experience value estimation unit 14 unifies each alphabet into a lowercase letter when the alphabet is included in the other user name or the target user name in calculating a Levenshtein distance between the other user name and the target user name. The experience value estimation unit 14 deletes characters used as delimiter characters such as “ ” and “.” from other user names and target user names. The experience value estimation unit 14 then calculates a Levenshtein distance between the other user name and the target user name, and divides the Levenshtein distance by the number of characters having the larger number of characters out of the other user name and the target user name, The Levenshtein distance is normalized, thereby the normalization of the Levenshtein distance D(C1, C2) is expressed by the following equation.

D_{normalize}(C1,C2)=d(C1,C2)/max(length(C1),length(C2))

The normalized Levenshtein distance (similarity) is calculated for each of the other user names. The experience value estimation unit 14 defines the maximum value of the normalized Levenshtein distances calculated for each of the other user names as the experience value c.

Subsequently, an experience value estimation unit 14 calculates a weighted sum of the experience value a, the experience value b and the experience value c as an experience value d (S204). In the weighted sum, weights for the experience value b and the experience value c may be obtained by applying an increase function to the age of the target user. This is because it is generally said that there are more people who use the Internet appropriately as the age is higher. In this case, the post-related information collection unit 11 may collect the age of the target user from the target SNS and include the age in the post-related information.

The experience value d may be calculated based on any two of the experience value a, the experience value b, and the experience value c, or the experience value d may be calculated based on any one of them. For example, any one of the experience value a, the experience value b, and the experience value c may be used as the experience value d as it is.

Subsequently, the experience value estimation unit 14 determines whether the experience value d is less than a threshold γ (S205). In a case where the experience value d is less than a threshold γ (Yes in S205), the experience value estimation unit 14 outputs the “posting content” and the “reply” of the target candidate posting information to the flammability determination unit 15 (S206). On the other hand, in a case where the experience value d is equal to or more than the threshold γ (No in S205), the step S206 is not executed. Therefore, in this case, the processing by the flammability determination unit 15 is not executed.

### [Flammability Determination Unit 15]

In a case where the experience value estimation unit 14 outputs the posting content and the reply, the flammability determination unit 15 inputs the posting content (hereinafter, referred to as “target posting content”) and the relay (hereinafter, referred to as “target relay”) and in a case where it is determined that the posting content has a high flammability, outputs the posting content to the corpus storage unit 19.

Specifically, the flammability determination unit 15 performs morphological analysis of the target posting content and the reply, and determines whether a word including negative meaning is included in a morpheme group obtained as a result of the morphological analysis. The determination of whether the word is a word containing a negative meaning depends on the Japanese polarity dictionary to be used. For example, in the case of using a Japanese polarity dictionary in which a flag “positive” or “negative” is simply given to a word, the word to which the flag “negative” is given may be determined as a word including a negative meaning. On the other hand, when a Japanese polarity dictionary in which a negative degree (score) may be given is used, a threshold value for the score may be provided, and a word including a negative meaning is determined based on the threshold value. For example, when the range of the score is −1 (negative) to 1 (positive), a word whose score is less than 0 may be determined as a word including negative meaning.

When a word including a negative meaning is included in the morpheme group (that is, at least one of the target posting content and the reply), the flammability determination unit 15 determines that the flammability of the target posting content is high, and adds the target posting content to a corpus (a collection of the flaming posting contents) stored in the corpus storage unit 19 as the flaming posting content.

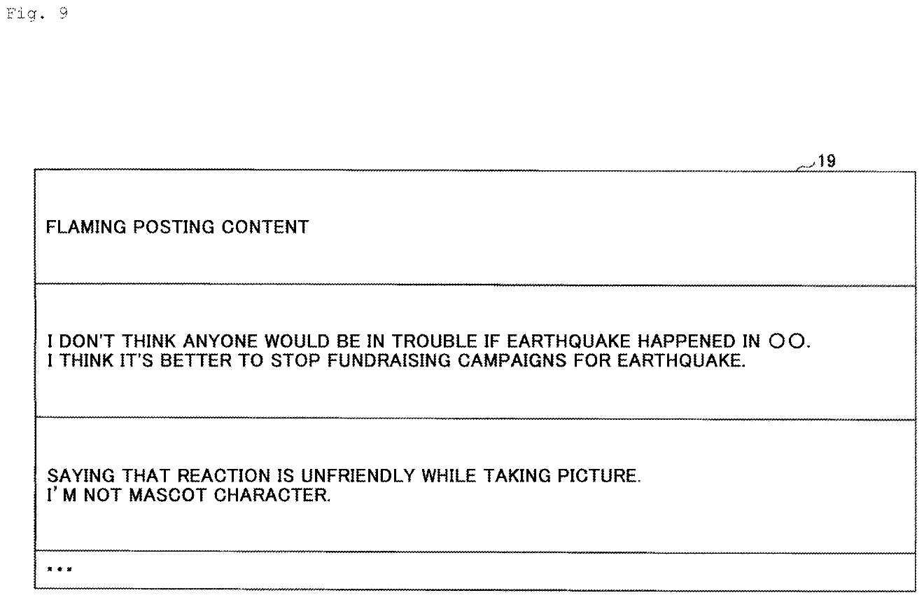

FIG. 9 is a diagram illustrating a configuration example of the corpus storage unit 19. As illustrated in FIG. 9, the corpus storage unit 19 stores the flaming post contents, which are determined by the flammability determination unit 15 to have a high flammability. In the example illustrated in FIG. 9, the following posting contents are stored as the flaming posting contents.

“I don't think anyone would be in trouble if the earthquake happened in XX. I think it's better to stop fundraising campaigns for the earthquake.”

“Saying that reaction is unfriendly while taking picture. I'm not mascot character.”

The respective pieces of flaming post contents included in such a corpus are learned by a model such as a neural network by machine learning, for example, and using the learned model, prevention on the flaming due to careless post can be expected. For example, when the posting is performed, the possibility of flaming of the posting content is estimated by the learned model, and when the possibility of flaming is high, the possibility of flaming may be notified to the poster before disclosing the posting content. In this case, the poster can review the posting content according to the notification.

As described above, according to the present embodiment, it is possible to determine the possibility of flaming due to carelessness for each posting content. Therefore, the posting contents having a high possibility of flaming due to carelessness can be collected.

The target SNS is an example of the first SNS. The other SNS is an example of the second SNS. The flaming candidate determination unit 12 is an example of a first determination unit. The threshold value γ is an example of a first threshold value. The experience value estimation unit 14 is an example of an estimation unit. The flammability determination unit 15 is an example of a second determination unit. The threshold α or the threshold β is an example of a second threshold.

Although the embodiments of the present invention have been described in detail above, the present invention is not limited to these particular embodiments, and various modifications and changes are possible within the scope of the gist of the present invention described in the claims.

### REFERENCE SIGNS LIST

10 Flammability determination device
11 Post-related information collection unit
12 Flaming candidate determination unit
13 Other SNS information acquisition unit
14 Experience value estimation unit
15 Flammability determination unit
16: Post-related information storage unit
17 Flaming candidate storage unit
18 Other SNS information storage unit
19 Corpus storage unit
20 SNS server
30 Other SNS server
100 Drive device
101 Recording medium
102 Auxiliary storage device
103 Memory device
104 Processor
105 Interface device
B Bus

1. A flammability determination device comprising:
circuitry configured to:
determine whether there is a predetermined difference between a post frequency of a first user to post a content in a first social networking service (SNS) and an average of post frequencies of all users to use the first SNS;
estimate, for the first user, an experience value indicating a level of experience related to use of the Internet, based on a possibility of use of a second SNS, upon determining that there is the difference, the second SNS being different from the first SNS, the second SNS being different from the first SNS;
determine whether a negative expression is included in the posted content, upon occurrence of a condition in which the experience value is less than a first threshold, and
add the posted content to a collection of post contents that cause a possibility of flaming.

2. The flammability determination device according to claim 1, wherein the circuitry is configured to:
determine whether the number of reactions from the other users to the posted content is equal to or greater than a second threshold, and
estimate the experience value upon determining that there is the predetermined difference and the number of reactions is equal to or greater than the second threshold.

3. The flammability determination device according to claim 1, wherein the circuitry is configured to estimate the experience value based on a similarity between a user name of the first user in the first SNS and a user name in the second SNS.

4. The flammability determination device according to claim 1, wherein the circuitry is configured to estimate the experience value based on one or more of (i) the number of times that of the posted content is reposted, (ii) a time period of the first SNS that is used by the first user, and (iii) the number of accounts that the first user blocks in the first SNS.

5. The flammability determination device according to claim 1, wherein the circuitry is configured to determine whether a negative word is included in the posted content or a second content that is posted as a reaction to the posted content, and
add the posted content to the collection, upon determining that the negative word is included.

6. A flammability determination method executed by a computer, the method comprising:
determining whether there is a predetermined difference between a post frequency of a first user to post a content in a first social network service (SNS) and an average of post frequencies of all users to use the first SNS;
estimating, for the first user, an experience value indicating a level of experience related to use of the Internet, based on a possibility of use of a second SNS, upon determining that there is the difference, the second SNS being different from the first SNS;
determining whether a negative expression is included in the posted content, upon occurrence of a condition in which the experience value is less than a first threshold value; and
adding the posted content to a collection of post contents that cause a possibility of flaming.

7. A non-transitory computer readable medium storing a program for causing a computer to execute the flammability determination method of claim 6.
